(19) United States
(12) Patent Application Publication
(10) Pub. No.: US 2016/0308878 A1
(43) Pub. Date: Oct. 20, 2016

(54) EXCEPTION PROMPTING METHOD, APPARATUS, AND SYSTEM USING THE SAME

(71) Applicant: Tencent Technology (Shenzhen) Company Limited, Shenzhen (CN)

(72) Inventors: Jie LIU, Shenzhen (CN); Qiuying CHEN, Shenzhen (CN); Weilin CAI, Shenzhen (CN); Haiyang WANG, Shenzhen (CN); Li LU, Shenzhen (CN)

(21) Appl. No.: 15/193,947

(22) Filed: Jun. 27, 2016

Related U.S. Application Data
(63) Continuation of application No. PCT/CN2014/091166, filed on Nov. 14, 2014.

(30) Foreign Application Priority Data
Apr. 14, 2014 (CN) 201410149117.6

(51) Int. Cl. H04L 29/06

(52) U.S. Cl. CPC H04L 63/102; H04L 63/083; H04L 51/046

(57) ABSTRACT

An exception prompting method at a communication platform having one or more processors and memory storing programs executed by the one or more processors is disclosed. The method includes configuring a user security interface; receiving a monitoring request on a target account from a user logging in to a client terminal; forwarding the monitoring request on the target account to a security platform through a service platform; receiving an exception prompt indicating an unusual activity of the target account from the security platform; generating an alarm notification of the target account based on the exception prompt; and forwarding the alarm notification of the target account to the client terminal.

### CROSS REFERENCE OF RELATED APPLICATIONS

This application is a continuation of International Application No. PCT/CN2014/091166, filed on Nov. 14, 2014, which claims priority to Chinese Patent Application No. 201410149117.6, entitled “EXCEPTION PROMPTING METHOD, APPARATUS, AND SYSTEM” filed on Apr. 14, 2014, which are incorporated by reference in their entireties.

### TECHNICAL FIELD

The present application relates to the field of computer application technologies, and in particular, to an exception prompting method, and an apparatus and a system using the exception prompting method.

### BACKGROUND

In a virtual network composed of a plurality of computers, a user is identified by user accounts registered at various service platforms. The user may log in to a service platform using a preset user account, and use the services provided by the service platform. As the service platform may provide multiple services to its users, a registered user may also have multiple sub accounts in regard to the multiple services, respectively. For example, an instant communication platform may provide game services, and thus, a registered user of the instant communication platform may also own multiple game user accounts. As such, it is critically important for the service provider to protect the securities of its user accounts.

Current technologies provide protection to user accounts at the log-in stage. When a user attempts to log in to a service platform, he or she has to provide correct user name and password, and in addition, a verification code is required for further security protection. The verification code may be a security card verification code, an electric verification code, or a cell phone verification code, etc.

However, the current technologies to protect the securities of the user accounts are complicated and require multiple steps of input. Further, the user has to carry the security card and the cell phone in order to log in. If the security card or the cell phone is lost, the user may be unable to log in to the service platform. Further, it is also easy to hack the verification codes provided through the security card and the cell phone, and therefore, the current technologies to protect the securities of the user accounts are not effective.

### SUMMARY

According to some embodiments of the present application, an exception prompting method comprises at a communication platform having one or more processors and memory storing programs executed by the one or more processors, configuring a user security interface; receiving a monitoring request on a target account from a user logging in to a client terminal; forwarding the monitoring request on the target account to a security platform through a service platform; receiving an exception prompt indicating an unusual activity of the target account from the security platform; generating an alarm notification of the target account based on the exception prompt; and forwarding the alarm notification of the target account to the client terminal.

In some embodiments, configuring the user security interface further comprises receiving a conversation request from the user logging in to the client terminal; establishing a conversation session between the client terminal and the service platform; receiving a monitoring configuration request from the user logging in to the client terminal; forwarding the monitoring configuration request to the service platform; receiving the user security interface that corresponds to the monitoring configuration request from the service platform; and forwarding the user security interface to the client terminal.

In some embodiments, configuring the user security interface further comprises receiving a monitoring configuration request from the user logging in to the client terminal; retrieving a service identifier from the monitoring configuration request; generating the user security interface that corresponds to the monitoring configuration request; and forwarding the user security interface to the client terminal.

In some embodiments, the target account is configured to be a communication account of the user provided by the communication platform, or a service account of the user provided by the service platform.

In some embodiments, if the target account is the communication account, the communication platform is configured to initiate a communication conversation with the communication account, and forward the alarm notification as a conversation message.

In some embodiments, the user security interface is configured to receive input of a communication identifier associated with the target account, and prompt the user whether to enable security monitoring.

In some embodiments, the communication platform is configured to forward the alarm notification based on the communication identifier associated with the target account.

In some embodiments, the exception prompting method further comprises retrieving contents of the unusual activity of the target account from the exception prompt; inputting the contents of the unusual activity of the target account in a preset template; and generating the alarm notification including the target account and the contents of the unusual activity of the target account in the preset template.

In some embodiments, the exception prompting method further comprises receiving a locking instruction in regards to the target account from the user logging in to the client terminal; and forwarding the locking instruction in regards to the target account to the security platform, wherein the locking instruction includes one or more user accounts to be locked, a time period that the one or more user accounts to be locked, and a password change instruction.

According to some embodiments of the present application, an exception prompting method comprises at a service platform having one or more processors and memory storing programs executed by the one or more processors, receiving a monitoring request on a target account from a communication platform; forwarding the monitoring request on the target account to a security platform; detecting whether the target account is logged in to the service platform; if the target account is logged in to the service platform, collecting service data of the target account; forwarding the service data of the target account to the security platform; if an unusual activity is detected in the service data of the target account, receiving a locking instruction in regards to the target account from the security platform; and stopping activities related to the target account.

According to some embodiments of the present application, an exception prompting method comprises at a security platform having one or more processors and memory storing programs executed by the one or more processors, receiving a monitoring request on a target account from a communication platform through a service platform; receiving service data of the target account from the service platform; monitoring whether an unusual activity occurs in the service data of the target account; if an unusual activity occurs, sending an exception prompt indicating the unusual activity of the target account to the communication platform; receiving a locking instruction in regards to the target account from the communication platform; and forwarding the locking instruction to the service platform to stop activities related to the target account.

In some embodiments, the exception prompting method further comprises retrieving a communication identifier associated with the target account from the monitoring request; and storing the target account and the communication identifier associated with the target account.

According to some embodiments of the present application, a exception prompting system, comprises a communication platform server configured with a communication platform, having one or more processors and memory storing one or more programs for execution by the one or more processors, the one or more programs including instructions for: configuring a user security interface; receiving a monitoring request on a target account from a user logging in to a client terminal; forwarding the monitoring request on the target account to a security platform through a service platform; receiving an exception prompt indicating an unusual activity of the target account from the security platform; generating an alarm notification of the target account based on the exception prompt; and forwarding the alarm notification of the target account to the client terminal.

According to some embodiments of the present application, an exception prompting system comprises a service platform server configured with a service platform, having one or more processors and memory storing one or more programs for execution by the one or more processors, the one or more programs including instructions for: receiving a monitoring request on a target account from a communication platform; forwarding the monitoring request on the target account to a security platform; detecting whether the target account is logged in to the service platform; if the target account is logged in to the service platform, collecting service data of the target account; and forwarding the service data of the target account to the security platform.

According to some embodiments of the present application, an exception prompting system comprises a security platform server configured with a security platform, having one or more processors and memory storing one or more programs for execution by the one or more processors, the one or more programs including instructions for receiving a monitoring request on a target account from a communication platform through a service platform; receiving service data of the target account from the service platform; monitoring whether an unusual activity occurs in the service data of the target account; and if an unusual activity occurs, sending an exception prompt indicating the unusual activity of the target account to the communication platform.

According to some embodiments of the present application, a non-transitory computer readable storage medium, storing one or more programs for execution by one or more processors of a communication platform server configured with a communication platform includes instructions for configuring a user security interface; receiving a monitoring request on a target account from a user logging in to a client terminal; forwarding the monitoring request on the target account to a security platform through a service platform; receiving an exception prompt indicating an unusual activity of the target account from the security platform; generating an alarm notification of the target account based on the exception prompt; and forwarding the alarm notification of the target account to the client terminal.

According to some embodiments of the present application, a non-transitory computer readable storage medium, storing one or more programs for execution by one or more processors of a service platform server configured with a service platform includes instructions for receiving a monitoring request on a target account from a communication platform; forwarding the monitoring request on the target account to a security platform; detecting whether the target account is logged in to the service platform; if the target account is logged in to the service platform, collecting service data of the target account; and forwarding the service data of the target account to the security platform.

According to some embodiments of the present application, a non-transitory computer readable storage medium, storing one or more programs for execution by one or more processors of a security platform server configured with a security platform includes instructions for receiving a monitoring request on a target account from a communication platform through a service platform; receiving service data of the target account from the service platform; monitoring whether an unusual activity occurs in the service data of the target account; and if an unusual activity occurs, sending an exception prompt indicating the unusual activity of the target account to the communication platform.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

To illustrate the technical solutions according to the embodiments of the present application or in the prior art more clearly, the accompanying drawings for describing the embodiments or the prior art are introduced briefly in the following. A is apparent, the accompanying drawings in the following description are only some embodiments of the present application, and a person of ordinary skill in the art can derive other drawings from the accompanying drawings without creative efforts.

FIG. 1 is an illustrative flowchart of an exception prompting method according to an embodiment of the present application;

FIG. 2 is an illustrative flowchart of another exception prompting method according to an embodiment of the present application;

FIG. 3 is an illustrative diagram of a communication identifier binding interface according to an embodiment of the present application;

FIG. 4 is an illustrative diagram of enabling a security monitoring interface according to an embodiment of the present application;

FIG. 5 is an illustrative diagram of a notification interface of an alarm notification according to an embodiment of the present application;

FIG. 6 is an illustrative diagram of a user setting interface for locking according to an embodiment of the present application;

FIG. 7 is an illustrative flowchart of another exception prompting method according to an embodiment of the present application;

FIG. 8 is an illustrative diagram of a specific interaction of an exception prompting method according to an embodiment of the present application;

FIG. 9 is an illustrative diagram of another specific interaction of an exception prompting method according to an embodiment of the present application;

FIG. 10 is an illustrative flowchart of another exception prompting method according to an embodiment of the present application;

FIG. 11 is an illustrative flowchart of another exception prompting method according to an embodiment of the present application;

FIG. 12 is an illustrative flowchart of another exception prompting method according to an embodiment of the present application;

FIG. 13 is an illustrative diagram of an exception prompting system according to an embodiment of the present application;

FIG. 14 is an illustrative computer diagram of an exception prompting apparatus according to an embodiment of the present application;

FIG. 15 is an illustrative computer diagram of another exception prompting apparatus according to an embodiment of the present application; and

FIG. 16 is an illustrative computer diagram of still another exception prompting apparatus according to an embodiment of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. As is apparent, the described embodiments are merely a part rather than all of the embodiments of the present application. All other embodiments obtained by a person of ordinary skill in the art based on the embodiments of the present application without creative efforts shall fall within the protection scope of the present application.

According to the embodiments of the present application, a communication platform such as an instant communication application platform, a security platform such as a security monitoring center platform, and a service platform such as a game application platform may cooperate together to monitor the activities of the user accounts. A user may launch the security monitoring function from a client terminal, and send the monitoring request on a target account to the security platform through the communication platform. The service platform may access user log in, and collect user account activities on the service platform. The service platform may also authorize the security platform to monitor the service data of the user account. The security platform may monitor the target account activity on the service platform in real-time, or by analyzing the service data of the target account sent from the service platform. The security platform may send an exception notification to the communication platform when an unusual activity of the target account occurs. Upon receiving the exception notification, the communication platform may notify the user instantly so that the user can choose to lock related accounts. According to the present application, various verification operations to secure a user account can be avoided, and user account protection is more effective.

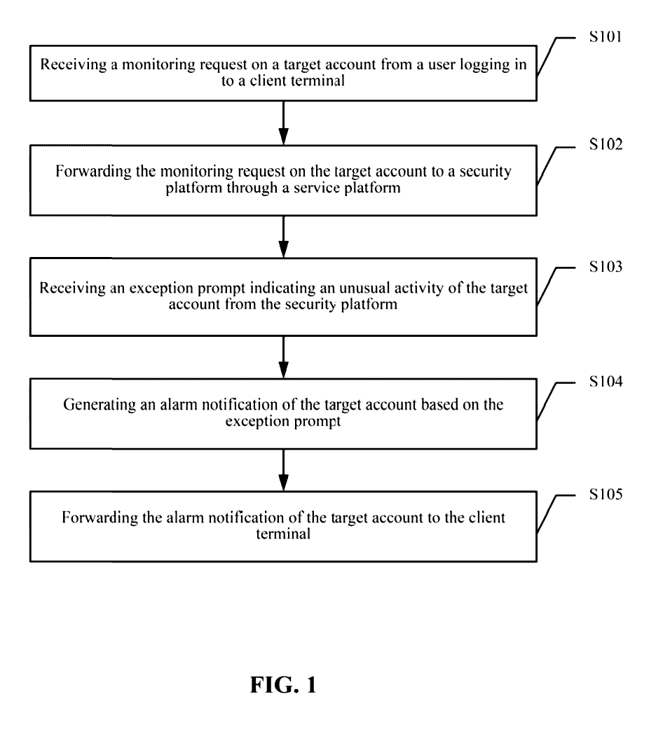

FIG. 1 is an illustrative flowchart of an exception prompting method according to an embodiment of the present application. The exception prompting method according to the embodiment in FIG. 1 may be implemented on a communication platform having one or more processors and memory storing programs for execution by the one or more processors, and may include steps discussed below.

At step S101, a monitoring request on a target account is received from a user logging in to a client terminal.

In some embodiments, a user security interface may be configured at the communication platform before a monitoring request is sent. A user may operate on the security interface on the communication platform to input a request to monitor a target account of the user. In yet another embodiment, the user may interact with a service account of the user after logging in to the communication platform, and send the monitoring request to the service platform through the communication platform.

At step S102, the monitoring request on the target account is forwarded to a security platform through a service platform.

In some embodiment, the target account may be a communication account of the user provided by the communication platform, or a service account of the user provided by the service platform. In some embodiments, the service account may be a sub account of the communication account, and the communication account may also be used to access various services provided by the service platform, such as game services. In yet another embodiment, the user may input the target account in the user security interface, such as a game service account.

In some embodiments, the user security interface may receive input of a communication identifier associated with the target account, and prompt the user whether to enable security monitoring.

At step S103, an exception prompt indicating an unusual activity of the target account is received from the security platform.

In some embodiments, an unusual activity of the target account may be determined based on the log in location, log in duration, service operation after logging in, etc., for instance, whether the log in location is a preset location or a frequently visited location, whether the log in duration is among a frequently used range, or whether the service operation is similar to the user's previous operations. In a game service, the service operation may include the virtual currency transaction, equipment transaction, and transaction objects, etc. The security platform may collect the times of the virtual currency and the equipment transactions, and transaction frequencies between the user and other objects to determine whether an unusual activity is suspected.

At step S104, an alarm notification of the target account is generated based on the exception prompt.

In some embodiments, the communication platform may forward the alarm notification based on the communication identifier associated with the target account.

In some embodiments, the exception prompting method may further comprise retrieving contents of the unusual activity of the target account from the exception prompt; inputting the contents of the unusual activity of the target account in a preset template; and generating the alarm notification including the target account and the contents of the unusual activity of the target account in the preset template.

In some other embodiments, the alarm notification may further include a link address to process the target account. By clicking the link address, the user may quickly respond to the alarm notification, such as freeze the target account, related other accounts, and related services.

At step S105, the alarm notification of the target account is forwarded to the client terminal.

In some embodiments, if the target account is the communication account, the communication platform is configured to initiate a communication conversation with the communication account, and forward the alarm notification as a conversation message.

In some embodiments, a communication identifier may be associated with the target account; and the alarm notification may be forwarded to the client terminal using the communication identifier.

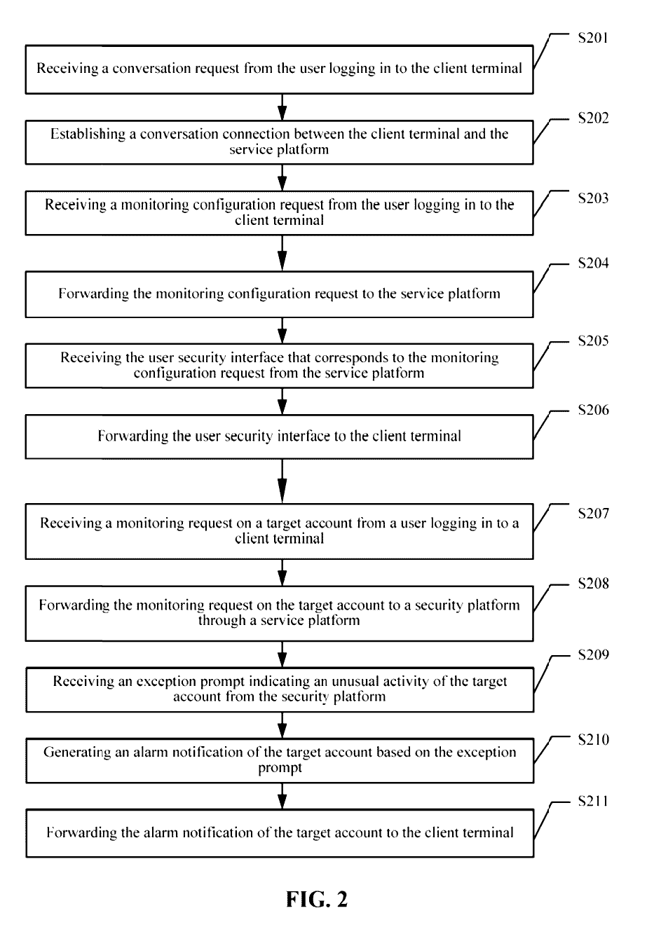

FIG. 2 is an illustrative flowchart of another exception prompting method according to an embodiment of the present application. The exception prompting method according to the embodiment in FIG. 2 may be implemented on a communication platform having one or more processors and memory storing programs for execution by the one or more processors, and may include steps discussed below.

At step S201, a conversation request is received from the user logging in to the client terminal.

At step S202, a conversation session is established between the client terminal and the service platform.

In some embodiments, the service account may be a public account registered in the communication platform by the service platform that is used to interact with the user, and further to respond to user's service requests.

At step S203, a monitoring configuration request is received from the user logging in to the client terminal.

At step S204, the monitoring configuration request is forwarded to the service platform.

At step S205, the user security interface that corresponds to the monitoring configuration request is received from the service platform.

At step S206, the user security interface is forwarded to the client terminal.

At step S207, a monitoring request on a target account is received from a user logging in to a client terminal.

At step S208, the monitoring request on the target account is forwarded to a security platform through a service platform.

At step S209, an exception prompt indicating an unusual activity of the target account is received from the security platform;

At step S210, an alarm notification of the target account is generated based on the exception prompt.

At step S211, the alarm notification of the target account is forwarded to the client terminal.

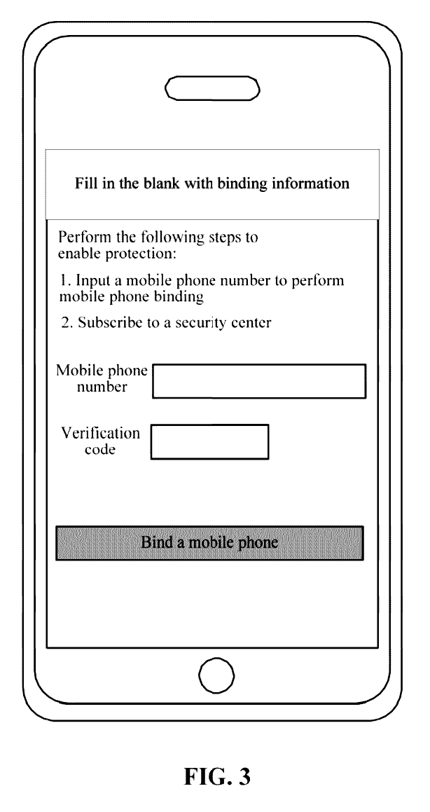

FIG. 3 is an illustrative diagram of a communication identifier binding interface according to an embodiment of the present application. The user security interface shown in FIG. 3 may include instructions to set up and enable user account protection. For example, the instructions may include inputting a mobile number to bind the security protection with a mobile phone, and subscribing to a security center such that the user can receive instant alarm on the unusual activities related to the user account.

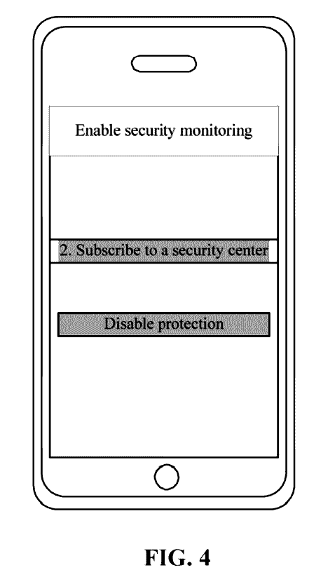

FIG. 4 is an illustrative diagram of enabling a security monitoring interface according to an embodiment of the present application. The user security interface shown in FIG. 4 may include instructions to enable security monitoring of a target account, subscribe to a security center, or disable security protection.

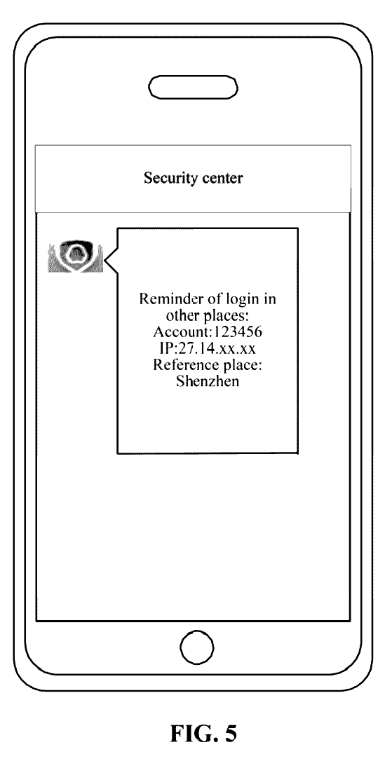

FIG. 5 is an illustrative diagram of a notification interface of an alarm notification according to an embodiment of the present application. The user security interface shown in FIG. 5 illustrates an alarm notification on a target account sent from a security center. The alarm notification may be a description of an unusual activity of the target account, including the target account information, the IP address where the target account logs in, the reference place where the target account logs in, etc.

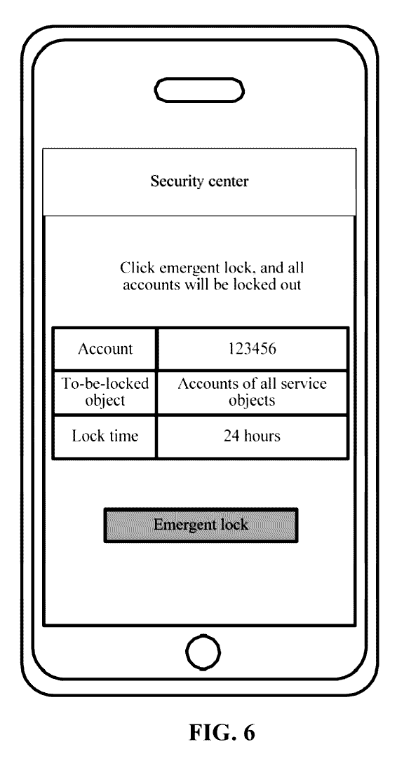

FIG. 6 is an illustrative diagram of a user setting interface for locking according to an embodiment of the present application. When an unusual activity of a target account is detected, the service platform may receive a locking instruction in regards to the target account. The user setting interface in FIG. 6 shows a prompt message to click the emergent lock button to lock all accounts associated with the target account, and the time period that the to-be-locked accounts will be locked out.

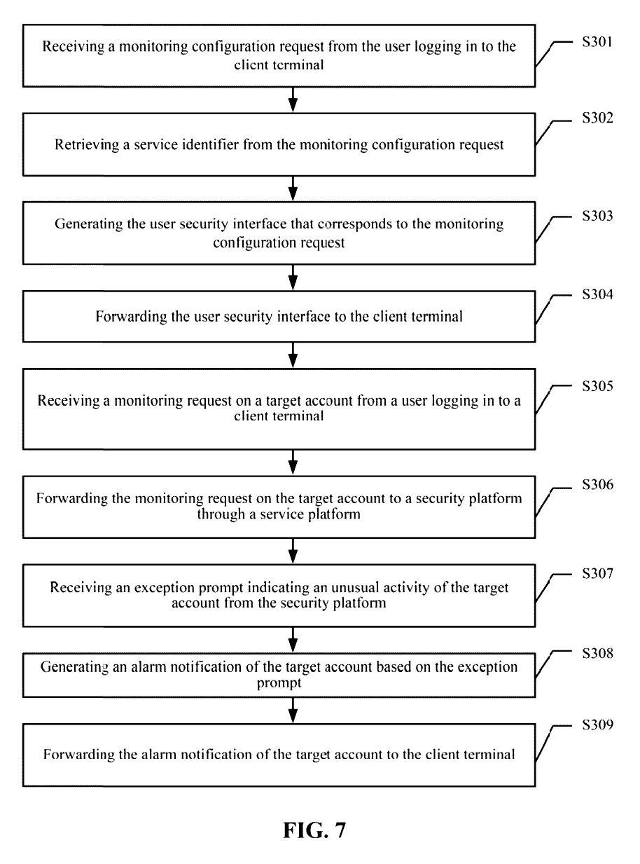

FIG. 7 is an illustrative flowchart of still another exception prompting method according to an embodiment of the present application. The exception prompting method according to the embodiment in FIG. 7 may be implemented on a communication platform having one or more processors and memory storing programs for execution by the one or more processors, and may include steps discussed below.

At step S301, a monitoring configuration request is received from the user logging in to the client terminal.

At step 302, a service identifier is retrieved from the monitoring configuration request.

At step S303, the user security interface that corresponds to the monitoring configuration request is generated.

At step S304, the user security interface is forwarded to the client terminal.

At step S305, a monitoring request on a target account is received from a user logging in to a client terminal.

At step 306, the monitoring request on the target account is forwarded to a security platform through a service platform.

At step S307, an exception prompt indicating an unusual activity of the target account is received from the security platform;

At step S308, an alarm notification of the target account is generated based on the exception prompt.

At step S309, the alarm notification of the target account is forwarded to the client terminal.

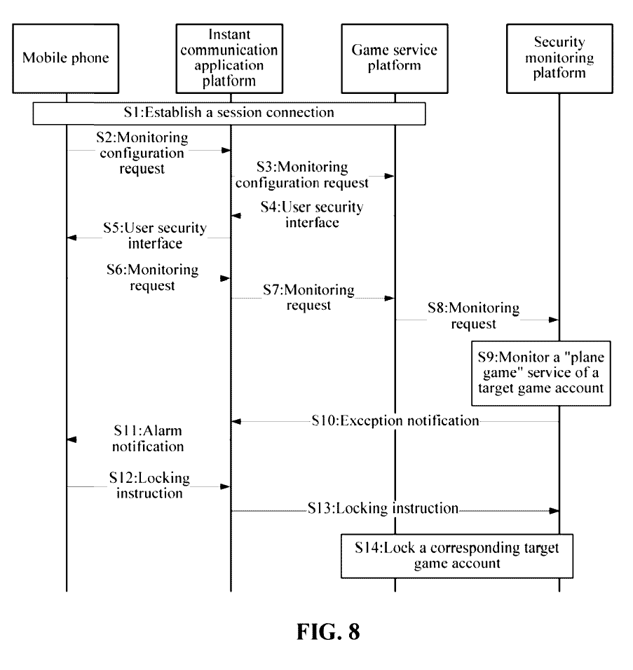

FIG. 8 is an illustrative diagram of a specific interaction of an exception prompting method according to an embodiment of the present application.

At step S1, a session connection is established between a client terminal and a service platform, illustrated by way of example with a mobile phone, and a game service platform.

At step S2, a monitoring configuration request is sent from the mobile phone to an application platform, for example, an instant communication application platform.

At step S3, the monitoring configuration request is forwarded to the game service platform.

At step S4, a user security interface that corresponds to the monitoring configuration request is sent from the game service platform to the instant communication application platform.

At step S5, the user security interface that corresponds to the monitoring configuration request is forwarded to the mobile phone.

At step S6, a monitoring request is sent from the mobile phone to the instant communication application platform.

At step S7, the monitoring request is sent from the instant communication application platform to the game service platform.

At step S8, the monitoring request is forwarded to the security monitoring platform, i.e., the security platform.

At step S9, the security monitoring platform monitors a “plan game” service of a target game account.

At step S10, an unusual activity is detected with the target game account, and an exception notification is generated at the security monitoring platform, and further forwarded to the instant communication application platform.

At step S11, an alarm notification is generated at the instant communication application platform based on the exception notification, and further forwarded to the mobile phone.

At step S12, a locking instruction is generated at the mobile phone, and further forwarded to the instant communication application platform.

At step S13, the locking instruction is forwarded to the security monitoring platform.

At step S14, the security monitoring platform instructs the game service platform to lock the corresponding target game account.

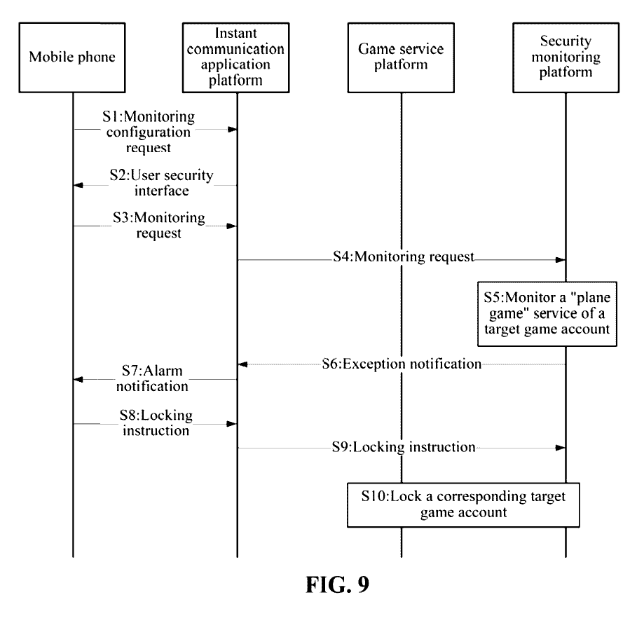

FIG. 9 is an illustrative diagram of another specific interaction of an exception prompting method according to an embodiment of the present application.

At step S1, a monitoring configuration request is sent from the mobile phone, i.e., the client terminal, to an instant communication application platform, i.e., the application platform.

At step S2, a user security interface that corresponds to the monitoring configuration request is sent from the game service platform to the instant communication application platform.

At step S3, a monitoring request is sent from the mobile phone to the instant communication application platform.

At step S4, the monitoring request is sent from the instant communication application platform to the security monitoring platform, i.e., the security platform.

At step S5, the security monitoring platform monitors a “plan game” service of a target game account.

At step S6, an unusual activity is detected with the target game account, and an exception notification is generated at the security monitoring platform, and further forwarded to the instant communication application platform.

At step S7, an alarm notification is generated at the instant communication application platform based on the exception notification, and further forwarded to the mobile phone.

At step S8, a locking instruction is generated at the mobile phone, and further forwarded to the instant communication application platform.

At step S9, the locking instruction is forwarded to the security monitoring platform.

At step S10, the security monitoring platform instructs the game service platform to lock the corresponding target game account.

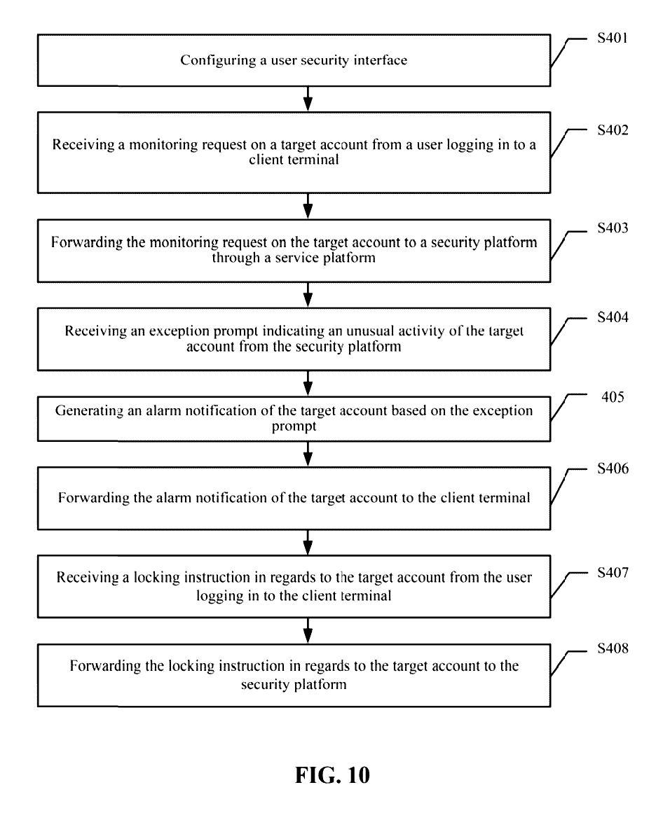

FIG. 10 is an illustrative flowchart of yet another exception prompting method according to an embodiment of the present application. The exception prompting method according to the embodiment in FIG. 10 may be implemented on a communication platform having one or more processors and memory storing programs for execution by the one or more processors, and may include steps discussed below.

At step S401, a user security interface is configured at the communication platform.

At step S402, a monitoring request on a target account is received from a user logging in to a client terminal.

At step S403, the monitoring request on the target account is forwarded to a security platform through a service platform.

At step S404, an exception prompt indicating an unusual activity of the target account is received from the security platform.

At step S405, an alarm notification of the target account is generated based on the exception prompt.

At step S406, the alarm notification of the target account is forwarded to the client terminal.

At step S407, a locking instruction in regards to the target account is received from the user logging in to the client terminal.

At step S408, the locking instruction in regards to the target account is forwarded to the security platform.

In some embodiments, the locking instruction includes one or more user accounts to be locked, a time period that the one or more user accounts to be locked, and a password change instruction, etc.

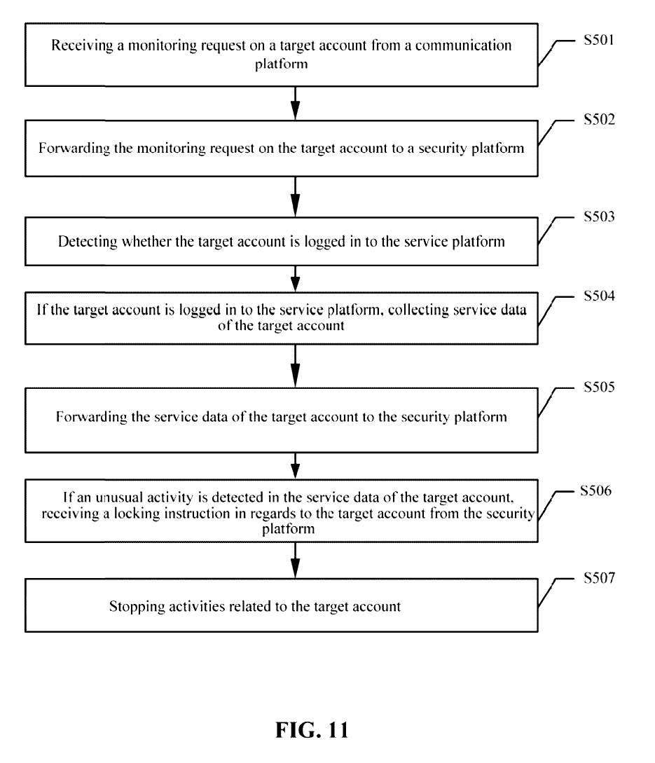

FIG. 11 is an illustrative flowchart of yet another exception prompting method according to an embodiment of the present application. The exception prompting method according to the embodiment in FIG. 11 may be implemented on a service platform having one or more processors and memory storing programs for execution by the one or more processors, and may include steps discussed below.

At step S501, a monitoring request on a target account is received from a communication platform.

In some embodiments, the target account may be a service account of the user registered in the service platform, for instance, a game service account registered to play an online game. In yet another embodiment, the target account may be a communication account of an instant communication application, and the user may also own multiple sub accounts under the communication account in regards to the various services, i.e., service accounts.

At step S502, the monitoring request on the target account is forwarded to a security platform.

In some embodiments, the service platform may authorize the security platform to monitor the activities of a target account.

At step S503, a decision is made as to whether the target account is logged in to the service platform.

At step S504, if the target account is logged in to the service platform, service data of the target account is collected.

At step S505, the service data of the target account is forwarded to the security platform.

At step S506, if an unusual activity is detected in the service data of the target account, a locking instruction in regards to the target account is received from the security platform.

In some embodiments, the unusual activities of a target account may be detected under the circumstances discussed below.

(1) When the log in location of the target account is not within a preset location area, the security platform may determine that an unusual activity occurs.

(2) When the log in time of the target account is not within a preset time range, the security platform may determine that an unusual activity occurs.

(3) When the frequency of information data transfer from a role that the target account plays exceeds a preset threshold, the security platform may determine that an unusual activity occurs.

(4) When the information data is transferred to an object that does not satisfy a preset condition, the security platform may determine that an unusual activity occurs.

(5) When the operation data of the role that the target account plays does not satisfy a preset operation rule, the security platform may determine that an unusual activity occurs.

At step S507, activities related to the target account is stopped by the service platform.

In some embodiments, when an unusual activity is detected in the service data of the target account, all accounts related to the target account may be frozen.

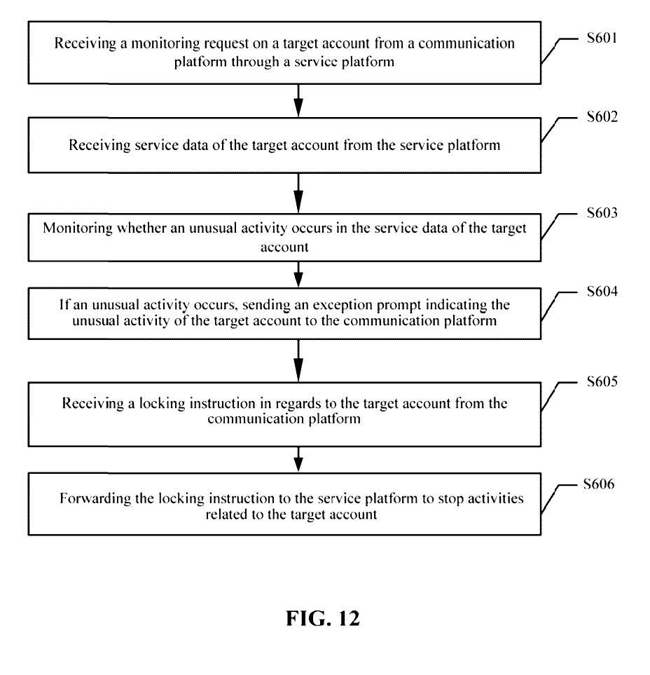

FIG. 12 is an illustrative flowchart of yet another exception prompting method according to an embodiment of the present application. The exception prompting method according to the embodiment in FIG. 12 may be implemented on a security platform having one or more processors and memory storing programs for execution by the one or more processors, and may include steps discussed below.

At step S601, a monitoring request on a target account is received from a communication platform through a service platform.

At step S602, service data of the target account is received from the service platform.

At step S603, the security platform monitors whether an unusual activity occurs in the service data of the target account.

In some embodiments, the security platform may apply a preset monitoring scheme to monitor the activities of the target account. The activities of the target account may include the log in events of the target account on the service platform, and one or more service operation events that correspond to the target account, etc. By analyzing the service data of the target account during log in and operation, the security platform may determine whether an unusual activity occurs.

At step S604, if an unusual activity occurs, an exception prompt indicating the unusual activity of the target account is sent to the communication platform.

In some embodiments, the exception prompting method may further include retrieving a communication identifier associated with the target account from the monitoring request; and storing the target account and the communication identifier associated with the target account.

At step S605, a locking instruction in regards to the target account is received from the communication platform.

At step S606, the locking instruction is forwarded to the service platform to stop activities related to the target account.

According to the present application, the security of a target account may be monitored through a communication platform such as an instant communication application. The user may launch a security monitoring process on the target account on the communication platform using a communication account of the user. The communication platform may cooperate with the service platform and the security platform to generate an exception notification if an unusual activity of the target account occurs, and notify the user with an alarm notification through the communication platform. Accordingly, the present application simplifies the user operation on the account security monitoring. Further, the present application provides a user security interface that can be pre-configured before the security monitoring. When an alarm notification is received, the user may quickly respond to the alarm notification by following the protecting instructions on the security interface, and therefore, the security of the user account can be protected more effectively.

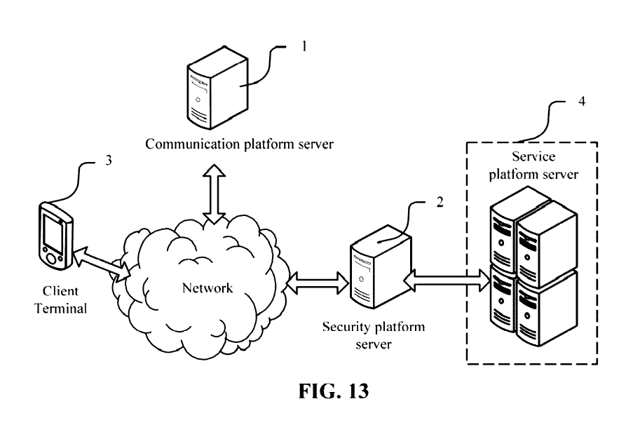

FIG. 13 is an illustrative diagram of an exception prompting system according to an embodiment of the present application. The exception prompting system according to the embodiment shown in FIG. 13 may include a communication platform server 1, a security platform server 2, a client terminal 3, and a service platform server 4. The communication platform, the security platform server, the client terminal, and the service platform may communication with each other through a network.

The communication platform server 1 may be configured with a communication platform having one or more processors and memory storing programs executed by the one or more processors, where the programs may include instructions for configuring a user security interface; receiving a monitoring request on a target account from a user logging in to a client terminal; forwarding the monitoring request on the target account to a security platform through a service platform; receiving an exception prompt indicating an unusual activity of the target account from the security platform; generating an alarm notification of the target account based on the exception prompt; and forwarding the alarm notification of the target account to the client terminal.

The security platform server 2 may be configured with a security platform having one or more processors and memory storing programs executed by the one or more processors, where the programs may include instructions for receiving a monitoring request on a target account from a communication platform through a service platform; receiving service data of the target account from the service platform; monitoring whether an unusual activity occurs in the service data of the target account; if an unusual activity occurs, sending an exception prompt indicating the unusual activity of the target account to the communication platform; receiving a locking instruction in regards to the target account from the communication platform; and forwarding the locking instruction to the service platform to stop activities related to the target account.

The service platform server 4 may be configured with a service platform having one or more processors and memory storing programs executed by the one or more processors, where the programs may include instructions for receiving a monitoring request on a target account from a communication platform; forwarding the monitoring request on the target account to a security platform; detecting whether the target account is logged in to the service platform; if the target account is logged in to the service platform, collecting service data of the target account; forwarding the service data of the target account to the security platform; if an unusual activity is detected in the service data of the target account, receiving a locking instruction in regards to the target account from the security platform; and stopping activities related to the target account.

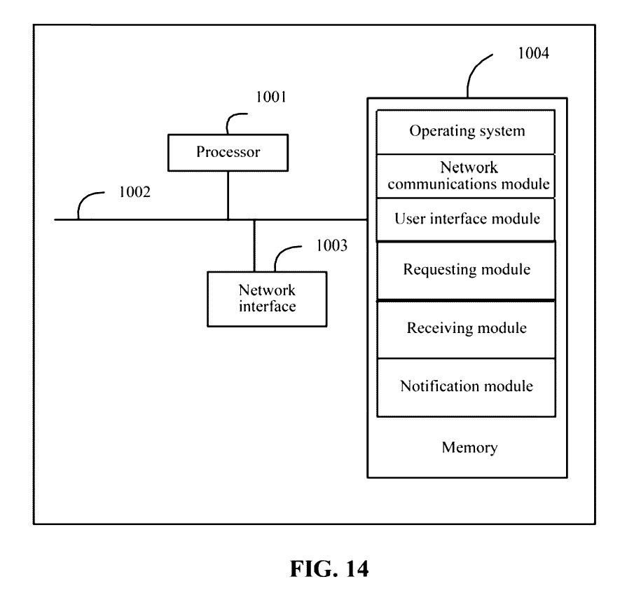

FIG. 14 is an illustrative computer diagram of an exception prompting apparatus according to an embodiment of the present application. The exception prompting apparatus according to the embodiment shown in FIG. 14 may be a communication platform server configured with one or more processors 1001, bus line 1002, network interface 1003, and memory 1004 storing one or more programs for execution by the one or more processors 1001. The one or more programs may include an operation system, a network communication module, a user interface module, a requesting module, a receiving module, and a notification module. The network communication module may be configured to communication with a client terminal, a service platform, a security platform, etc. The user interface module may be configured to generate a user security interface, and receive user inputs from the security interface. The requesting module may be configured to receive receiving a monitoring request on a target account from a user logging in to a client terminal, and forward the monitoring request to the security platform through the service platform. The receiving module may be configured to receive an exception notification indicating an unusual activity of the target account from the security platform from the security platform. The notification module may be configured to generate an alarm notification based on the exception prompt, and forward the alarm notification to the client terminal.

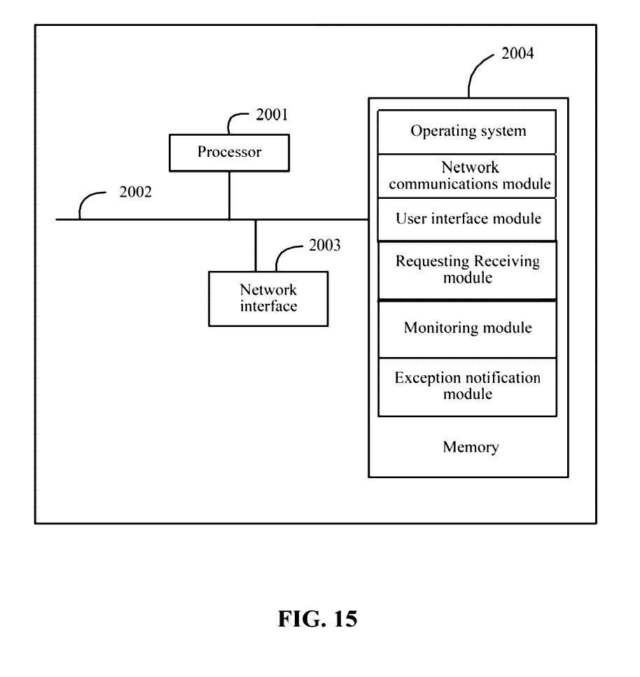

FIG. 15 is an illustrative computer diagram of another exception prompting apparatus according to an embodiment of the present application. The exception prompting apparatus according to the embodiment shown in FIG. 15 may be a security platform server configured with one or more processors 2001, bus line 2002, network interface 2003, and memory 2004 storing one or more programs for execution by the one or more processors 2001. The one or more programs may include an operation system, a network communication module, a user interface module, a requesting receiving module, a monitoring module, and an exception notification module. The network communication module may be configured to communication with a service platform and a communication platform, etc. The requesting receiving module may be configured to receive monitoring request from a communication platform through a service platform. The monitoring module may be configured to receive service data of the target account from the service platform, and monitor whether an unusual activity occurs in the service data of the target account. The exception notification module may be configured to send an exception notification indicating the unusual activity of the target account to the communication platform when an unusual activity of the target account is detected. The requesting receiving module may be further configured to receive a locking instruction in regards to the target account from the communication platform, and forward the locking instruction to the service platform to stop activities related to the target account.

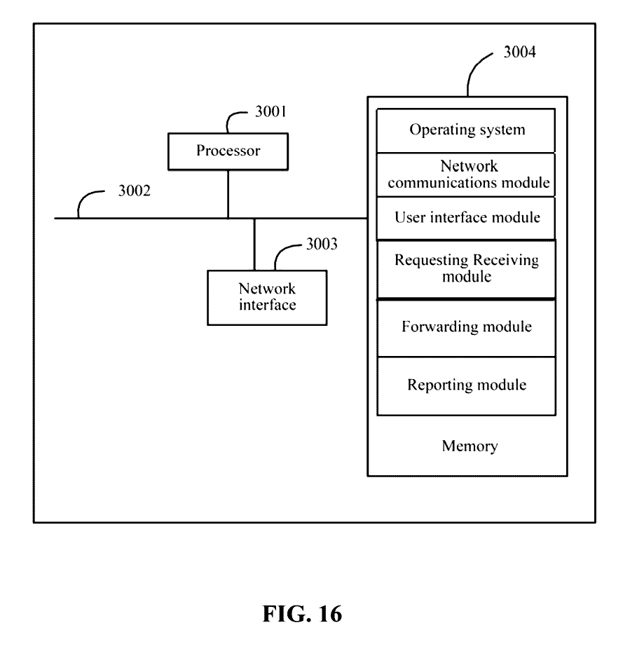

FIG. 16 is an illustrative computer diagram of still another exception prompting apparatus according to an embodiment of the present application. The exception prompting apparatus according to the embodiment shown in FIG. 16 may be a service platform server configured with one or more processors 3001, bus line 3002, network interface 3003, and memory 3004 storing one or more programs for execution by the one or more processors 3001. The one or more programs may include an operation system, a network communication module, a user interface module, a requesting receiving module, a forwarding module, and a reporting notification module. The network communication module may be configured to communication with a communication platform and a security platform, etc. The requesting receiving module may be configured to receive a monitoring request from a communication platform. The forwarding module may be configured to forward the monitoring request to a security platform. The reporting notification module may be configured to detect whether the target account is logged in to the service platform, and if the target account is logged in to the service platform, collect service data of the target account and forward the service data of the target account to the security platform. The requesting receiving module may be further configured to receive a locking instruction in regards to the target account from the security platform if an unusual activity is detected in the service data of the target account, and stop activities related to the target account.

The foregoing descriptions are merely preferred embodiments of the present application, and are definitely not intended to limit the scope of the claims of the present application. Any equivalent variation made according to the claims of the present application shall still fall within the scope of the present application.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the invention. As used in the description of the invention and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An exception prompting method comprising:
at a communication platform having one or more processors and memory storing programs executed by the one or more processors,
configuring a user security interface;
receiving a monitoring request on a target account from a user logging in to a client terminal;
forwarding the monitoring request on the target account to a security platform through a service platform;
receiving an exception prompt indicating an unusual activity of the target account from the security platform;
generating an alarm notification of the target account based on the exception prompt; and
forwarding the alarm notification of the target account to the client terminal.

2. The exception prompting method of claim 1, wherein configuring the user security interface further comprises:
receiving a conversation request from the user logging in to the client terminal;
establishing a conversation session between the client terminal and the service platform;
receiving a monitoring configuration request from the user logging in to the client terminal;
forwarding the monitoring configuration request to the service platform;
receiving the user security interface that corresponds to the monitoring configuration request from the service platform; and
forwarding the user security interface to the client terminal.

3. The exception prompting method of claim 1, wherein configuring the user security interface further comprises:
receiving a monitoring configuration request from the user logging in to the client terminal;
retrieving a service identifier from the monitoring configuration request;
generating the user security interface that corresponds to the monitoring configuration request; and
forwarding the user security interface to the client terminal.

4. The exception prompting method of claim 1, wherein
the target account is configured to be a communication account of the user provided by the communication platform, or a service account of the user provided by the service platform.

5. The exception prompting method of claim 4, wherein
if the target account is the communication account, the communication platform is configured to initiate a communication conversation with the communication account, and forward the alarm notification as a conversation message.

6. The exception prompting method of claim 1, wherein the user security interface is configured to receive input of a communication identifier associated with the target account, and prompt the user whether to enable security monitoring.

7. The exception prompting method of claim 6, wherein
the communication platform is configured to forward the alarm notification based on the communication identifier associated with the target account.

8. The exception prompting method of claim 1, further comprises:
retrieving contents of the unusual activity of the target account from the exception prompt;
inputting the contents of the unusual activity of the target account in a preset template; and
generating the alarm notification including the target account and the contents of the unusual activity of the target account in the preset template.

9. The exception prompting method of claim 1, further comprises:
receiving a locking instruction in regards to the target account from the user logging in to the client terminal; and
forwarding the locking instruction in regards to the target account to the security platform, wherein
the locking instruction includes one or more user accounts to be locked, a time period that the one or more user accounts to be locked, and a password change instruction.

10. An exception prompting method comprising:
at a security platform having one or more processors and memory storing programs executed by the one or more processors,
receiving a monitoring request on a target account from a communication platform through a service platform;
receiving service data of the target account from the service platform;
monitoring whether an unusual activity occurs in the service data of the target account;
if an unusual activity occurs, sending an exception prompt indicating the unusual activity of the target account to the communication platform;
receiving a locking instruction in regards to the target account from the communication platform; and
forwarding the locking instruction to the service platform to stop activities related to the target account.

11. The exception prompting method of claim 10, further comprises:
retrieving a communication identifier associated with the target account from the monitoring request; and
storing the target account and the communication identifier associated with the target account.

12. An exception prompting system, comprising:
a communication platform server configured with a communication platform, having one or more processors and memory storing one or more programs for execution by the one or more processors, the one or more programs including instructions for:
configuring a user security interface;
receiving a monitoring request on a target account from a user logging in to a client terminal;
forwarding the monitoring request on the target account to a security platform through a service platform;
receiving an exception prompt indicating an unusual activity of the target account from the security platform;
generating an alarm notification of the target account based on the exception prompt; and
forwarding the alarm notification of the target account to the client terminal.

13. The exception prompting system of claim 12, wherein the one or more programs further includes instructions for:
receiving a conversation request from the user logging in to the client terminal;
establishing a conversation session between the client terminal and the service platform;
receiving a monitoring configuration request from the user logging in to the client terminal;
forwarding the monitoring configuration request to the service platform;
receiving the user security interface that corresponds to the monitoring configuration request from the service platform; and
forwarding the user security interface to the client terminal.

14. The exception prompting system of claim 12, wherein the one or more programs further includes instructions for:
receiving a monitoring configuration request from the user logging in to the client terminal;
retrieving a service identifier from the monitoring configuration request;
generating the user security interface that corresponds to the monitoring configuration request; and
forwarding the user security interface to the client terminal.

15. The exception prompting system of claim 12, wherein
the target account is configured to be a communication account of the user provided by the communication platform, or a service account of the user provided by the service platform.

16. The exception prompting system of claim 15, wherein
if the target account is the communication account, the communication platform is configured to initiate a communication conversation with the communication account, and forward the alarm notification as a conversation message.

17. The exception prompting system of claim 12, wherein the user security interface is configured to receive input of a communication identifier associated with the target account, and prompt the user whether to launch an exception prompting function.

18. The exception prompting system of claim 17, wherein
the communication platform is configured to forward the alarm notification based on the communication identifier associated with the target account.

19. The exception prompting system of claim 12, wherein the one or more programs further includes instructions for:
retrieving contents of the unusual activity of the target account from the exception prompt;
inputting the contents of the unusual activity of the target account in a preset template; and
generating the alarm notification including the target account and the contents of the unusual activity of the target account in the preset template.

20. The exception prompting system of claim 12, wherein the one or more programs further includes instructions for:
receiving a locking instruction in regards to the target account from the user logging in to the client terminal; and
forwarding the locking instruction in regards to the target account to the security platform, wherein
the locking instruction includes one or more user accounts to be locked, a time period that the one or more user accounts to be locked, and a password change instruction.
